(19) United States
(12) Patent Application Publication
(10) Pub. No.: US 2015/0058118 A1
(43) Pub. Date: Feb. 26, 2015

(54) METHODS AND SYSTEMS FOR COMPLAINT DOCUMENTATION AND RESOLUTION

(71) Applicant: Sht Lst LLC, Austin, TX (US)

(72) Inventor: Ross Clurman, Austin, TX (US)

(73) Assignee: Sht Lst LLC, Austin, TX (US)

(21) Appl. No.: 14/460,642

(22) Filed: Aug. 15, 2014

Related U.S. Application Data
(60) Provisional application No. 61/867,969, filed on Aug. 20, 2013.

(51) Int. Cl. G06Q 30/02; G06Q 30/04

(52) U.S. Cl. CPC G06Q 30/0251; G06Q 30/0275; G06Q 30/04
USPC 705/14.49

(57) ABSTRACT

A system, method, and computer program for receiving and responding to complaints about a reviewable item. The system may receive the complaints from users, then electronically publish the complaints and display relevant advertisements therewith. Upon receipt of a complaint, the system may automatically send notifications to one of the advertisers owning the reviewable item of the complaint and/or may send an automated redress message to the complainant from the owner of the reviewable item. If a highest-biding advertiser also owns the reviewable item of the complaint, a redress management advertisement from that advertiser may be displayed with the complaint, such as a coupon or voucher only displayed to the user who originally authored the complaint. If the highest-bidding advertiser does not own the reviewable item, an alternative solution advertisement may be displayed with the complaint, promoting a similar or competing reviewable item.

### RELATED APPLICATIONS

This application claims priority benefit of a provisional application entitled, “Methods and Systems for Complaint Documentation and Resolution,” Ser. No. 61/867,969, filed Aug. 20, 2013 and incorporated by reference herein in its entirety.

### BACKGROUND

Consumers often wish to rate their satisfaction with products and services so that future consumers can decide whether to buy the products and services. Traditional ratings and reviews Web sites, as well as related web-based and software applications, allow a user to select from a predetermined set of rating levels for items such as known products, businesses, places, or service providers. For example, a rating system might allow a user to select the item and submit a ranking of any number of stars from a range of one to five. The number of stars, in this example, corresponds to the level of satisfaction or dissatisfaction the user wishes to express toward the item.

In addition to providing the user with the ability to select from a defined set of items and a predetermined range of rating levels, some ratings and reviews Web sites and systems allow the user to elaborate on the rating the user selected. For example, a rating system can allow the user to include text comments about the item.

Ratings and reviews Web sites and systems are typically aimed at collecting positive reviews and the corresponding positive publicity that a positive review creates. In many cases, the ratings and reviews systems and/or Web sites are affiliate marketers for online and electronic commerce retailers. For example, when a person selects a link to a merchant's website through the ratings and reviews site, the ratings and reviews site can be credited with a portion of the proceeds from any resulting sale. The owner of the ratings and reviews system therefore has a financial incentive to promote and collect positive reviews of products, businesses, places, and services or service providers.

Because of the way in which traditional ratings and reviews Web sites operate, negative reviews are minimized on these Web sites. Accordingly, when a consumer has a negative experience with a particular product, business, place, or service provider, the ratings and reviews Web sites and services make it difficult for the consumer to post his or her complaint, find a remedy, and seek redress.

### SUMMARY

Embodiments of the present invention solve the above-mentioned problems and provide a distinct advance in the art of complaint documentation and redress management. One embodiment of the invention is a computer program having code segments for receiving a complaint from a user, via an electronic computing device, regarding a reviewable item, and for electronically publishing the complaint for remote viewing by other people. Furthermore, the computer program may have a code segment for displaying to the user, along with the complaint, a redress management advertisement from an owner advertiser associated with the reviewable item or displaying an alternative solution advertisement from a non-owner advertiser not associated with the reviewable item.

Another embodiment of the invention provides a computer program having code segments for receiving a complaint from a user, via an electronic computing device, regarding a reviewable item, and for electronically publishing the complaint for remote viewing by other people. Furthermore, the computer program may have a code segment for determining whether to display to the user a redress management advertisement from an owner advertiser associated with the reviewable item or an alternative solution advertisement from a non-owner advertiser not associated with the reviewable item. This determining may be based on criteria submitted by the owner advertiser and the non-owner advertiser, and/or based on which of the owner and non-owner advertisers submits a highest bid. The redress management advertisement may be, for example, a coupon or voucher from the owner advertiser, while the alternative solution advertisement may promote a competing reviewable item from the non-owner advertiser. Next, the computer program may have a code segment for displaying the redress management advertisement or the alternative solution advertisement with the complaint based on results from executing the determining code segment.

Another embodiment of the invention provides a method for receiving and responding to complaints. The method may include the steps of receiving, with a server from an electronic computing device, a complaint from a user regarding a selected one of a plurality of reviewable items, and electronically publishing the complaint, thereby granting remote viewing access to other people over internet and communication channels via the server. The method may also include the step of receiving criteria from advertisers via their advertising accounts. The advertisers may include an owner advertiser associated with the selected one of the plurality of reviewable items in the complaint and the criteria may include advertisement bidding criteria. Next, the method may include the steps of sending notifications to the owner advertiser upon receipt of the complaint regarding the selected one of the reviewable items, and determining whether to display a redress management advertisement from the owner advertiser or an alternative solution advertisement from a non-owner advertiser not associated with the selected one of the reviewable items. This determining may be based on the criteria received from the advertisers and/or on which of the owner and non-owner advertisers has a highest bid for displaying the redress management or alternative solution advertisements with the complaint. The redress management advertisement may be a coupon or voucher from the owner advertiser, while the alternative solution advertisement may promote a competing one of the reviewable items from the non-owner advertiser. The method may additionally include a step of displaying the redress management advertisement or the alternative solution advertisement with the complaint, based on results of the determining step. Furthermore, the method may include the steps of receiving an automated redress message from the owner advertiser and sending the automated redress message to the user when the complaint regarding the selected one of the reviewable items is received, thereby attempting to resolve the issues in the complaint.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the preferred embodiments and the accompanying drawing figures.

### BRIEF DESCRIPTION OF THE DRAWING FIGURES

Embodiments of the present invention are described in detail below with reference to the attached drawing figures, wherein:

FIG. 1 is a block diagram of a system constructed in accordance with an embodiment of the present invention and configured for performing a method of documenting and resolving complaints and displaying advertising based on the complaints;

FIG. 2 is a block diagram of a mobile electronic device of the system of FIG. 1; and

FIG. 3 is a flow chart illustrating a method for receiving and responding to complaints in accordance with an embodiment of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

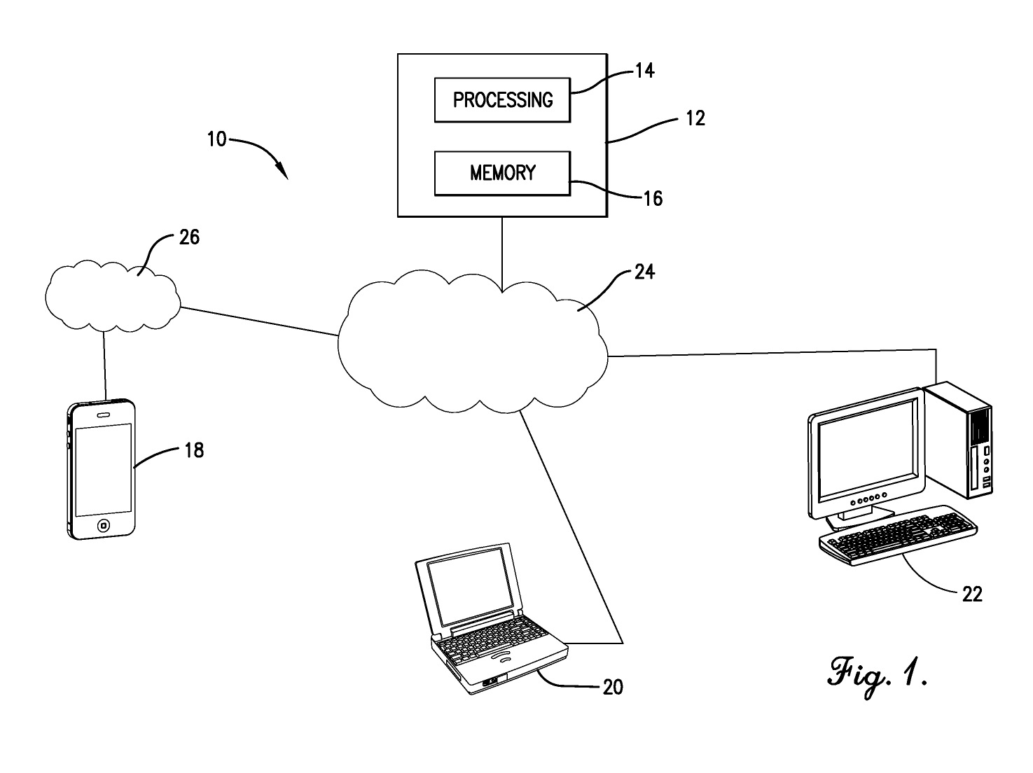

The present invention is a system, computer program, and method for documenting and resolving complaints by a user, and using those complaints to determine specific types of advertising to display to the user. As illustrated in FIG. 1, an exemplary computer and communication system 10 may be used to implement methods and computer programs described herein. The system 10 includes a web server or other electronic apparatus 12 having a processing device 14 and memory 16, as well as one or more computer programs for operating components of the system 10. The apparatus 12 may be accessed by one or more electronic computing devices 18,20,22 via a communications network 24 or a wireless network 26, or any other data communication methods known in the art. The components of the system 10 illustrated and described herein are merely examples of equipment that may be used to implement embodiments of the present invention and may be replaced with other equipment without departing from the scope of the present invention. Some of the illustrated components of the system 10 may also be combined and/or omitted.

The apparatus 12 may receive, store, and provide access to the data and information described herein. The apparatus 12 may also implement one or more computer programs for performing some of the functions described herein and may provide a web-based portal that can be accessed by the electronic computing devices 18-22 and other such electronic devices. In some embodiments, the apparatus 12 may reside in a personal computer or server that is accessible by remote users via the Internet or other wired or wireless communication techniques. Embodiments of the apparatus 12 may include one or more servers running Windows; LAMP (Linux, Apache HTTP server, MySQL, and PHP/Perl/Python); Java; AJAX; NT; Novel Netware; Unix; or any other software system. The apparatus 12 includes or has access to computer memory, such as the memory 16, and other hardware, such as the processing device 14, and software for receiving, storing, accessing, and transmitting information as described below. The apparatus 12 may also include conventional web hosting operating software, searching algorithms, and an Internet connection, and may be assigned a URL and corresponding domain name so that it can be accessed via the Internet in a conventional manner. In other embodiments, the apparatus 12 may be a personal computer, laptop, or any computing device operable to store information and execute software or computer codes associated with the procedures described herein.

The processing device 14 provides processing functionality for the apparatus 12 and may include any number of processors, microcontrollers, or other processing systems, and resident or external memory for storing data and other information accessed or generated by the apparatus 12. The processing device 14 may execute one or more software programs that implement the methods or code segments described herein. The processing device 14 is not limited by the materials from which it is formed or the processing mechanisms employed therein and, as such, may be implemented via semiconductor(s) and/or transistors (e.g., electronic integrated circuits (ICs)), and so forth.

The memory 16 is an example of device-readable storage media that provides storage functionality to store various data associated with the operation of the computer system 12, such as the software program and code segments mentioned above, or other data to instruct the processing device 14 and other elements of the computer system 12 to perform the method steps described herein. Although a single memory 16 is shown, a wide variety of types and combinations of memory may be employed. The memory 16 may be integral with the processing device 14, stand-alone memory, or a combination of both. The memory may include, for example, removable and non-removable memory elements such as RAM, ROM, Flash (e.g., SD Card, mini-SD card, micro-SD Card), magnetic, optical, USB memory devices, and so forth.

The electronic computing devices 18-22 may be any computing devices for remotely sending information to and receiving information from the apparatus 12 via the Internet or other communication networks, as described herein. The electronic computing devices 18-22 may be desktop computers, laptop computers, tablet computers, mobile phones, smart phones, personal digital assistants, multimedia devices, media players, game devices, combinations thereof, and so forth. Each of the electronic computing devices 18-22 preferably includes or can access an Internet browser and a conventional Internet connection such as a wireless broadband connection, DSL converter, or ISDN converter so that it can exchange data with the computer system 12 via the communications network 24.

The communications network 24 may be the Internet or any other communications network such as a local area network, a wide area network, or an intranet. The communications network 24 may include or be in communication with the wireless network 26, which may be capable of supporting wireless communications such as the wireless networks operated by AT&T, Verizon, or Sprint. The communications network 24 and wireless network 26 may also be combined or implemented with several different networks.

The wireless network 24 may include conventional switching and routing equipment. Specifically, the wireless network 26 may include, but is not limited to: networks configured for communications according to: one or more standard of the Institute of Electrical and Electronics Engineers (IEEE), such as 802.11 or 802.16 (Wi-Max) standards; Wi-Fi standards promulgated by the Wi-Fi Alliance; Bluetooth standards promulgated by the Bluetooth Special Interest Group; and so on. Wired communications are also contemplated such as through universal serial bus (USB), Ethernet, serial connections, and so forth.

The networks 24,26 described above are representative of a variety of different communication pathways and network connections which may be employed, individually or in combinations, to communicate among the components of the system 10. Thus, the networks 24,26 may be representative of communication pathways achieved using a single network or multiple networks. Further, the networks 24,26 are representative of a variety of different types of networks and connections that are contemplated including, but not limited to: the Internet; an intranet; a satellite network; a cellular network; a mobile data network; wired and/or wireless connections; and so forth.

Embodiments of the present technology may also comprise one or more computer programs stored in or on computer-readable medium residing on or accessible by the computer system 12 or the electronic computing devices 18-22. The computer programs may comprise listings of executable instructions for implementing logical functions in the processing device 14 and/or the electronic computing devices 18-22 and can be embodied in any non-transitory computer-readable medium, such as the memory 16, for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any non-transitory means that can contain, store, or communicate the programs. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

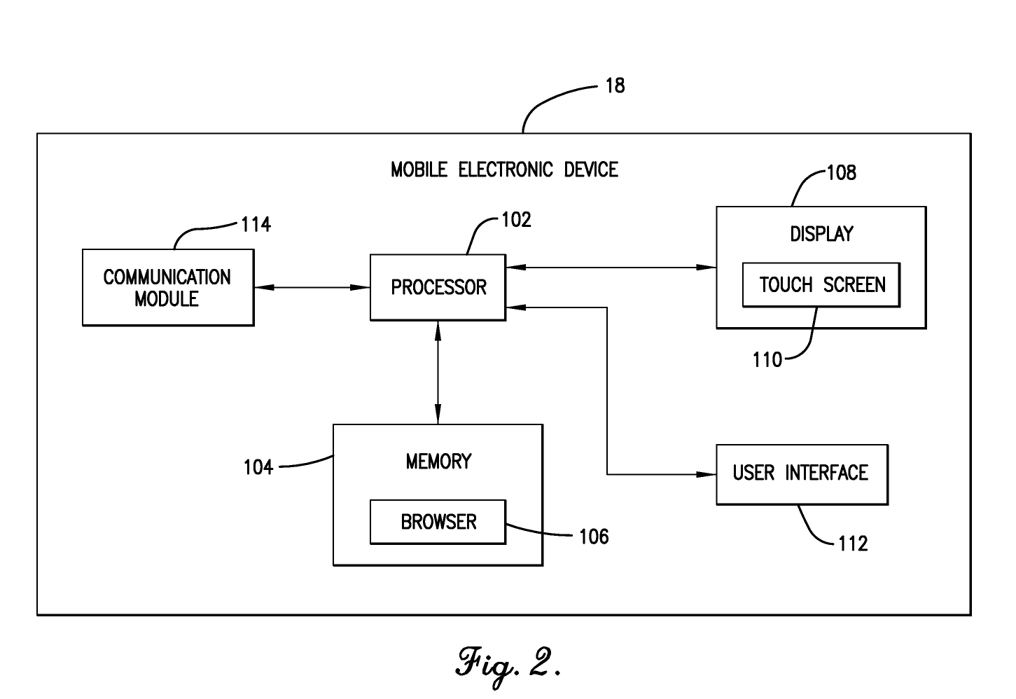

FIG. 2 illustrates one of the electronic computing devices 18-22 in more detail. Specifically, FIG. 2 illustrates mobile electronic device 18 comprising a processor 102 and a memory 104. Note that the components of the mobile electronic device 18 may also be included in any of the other electronic computing devices 20,22 referenced herein.

The processor 102 may provide processing functionality for the mobile electronic device 18 and may include any number of processors, microcontrollers, or other processing systems, and resident or external memory for storing data and other information accessed or generated by the mobile electronic device 18. The processor 102 may execute one or more software programs that implement the techniques and modules described herein. The processor 102 is not limited by the materials from which it is formed or the processing mechanisms employed therein and, as such, may be implemented via semiconductor(s) and/or transistors (e.g., electronic integrated circuits), and so forth.

The memory 104 may be integral with the processor 102, stand-alone memory, or a combination of both. The memory may include, for example, removable and non-removable memory elements such as RAM, ROM, Flash (e.g., SD Card, mini-SD card, micro-SD Card), magnetic, optical, USB memory devices, and the like. Although a single memory 104 is shown, a wide variety of types and combinations of memory may be employed.

The memory 104 is an example of device-readable storage media that provides storage functionality to store various data associated with the operation of the mobile electronic device 18, such as the software program and code segments mentioned above, or other data to instruct the processor 102 and other elements of the mobile electronic device 18 to perform the methods described herein. Specifically, the memory 104 may store software programs, apps, or other computer code therein that is executable by the processor 102 to perform a specific operation or group of operations to furnish functionality to the mobile electronic device 18. Example applications may include cellular telephone applications, instant messaging applications, email applications, photograph sharing applications, calendar applications, address book applications, video sharing apps, text messaging apps, and so forth.

The memory 104 and processor 102 may also include or have access to a browser 106. The browser 106 enables the mobile electronic device 18 to display and interact with content such as a webpage within the World Wide Web, a webpage provided by a web server in a private network, and so forth. The browser 106 may be configured in a variety of ways, as known in the art.

The mobile electronic device 18 may further include a display 108 to display information to a user of the mobile electronic device 18. The display 108 may comprise an LCD (Liquid Crystal Diode) display, a TFT (Thin Film Transistor) LCD display, an LEP (Light Emitting Polymer) or PLED (Polymer Light Emitting Diode) display, and so forth, configured to display text and/or graphical information such as a graphical user interface. The display 108 may be backlit via a backlight such that it may be viewed in the dark or other low-light environments. The display 108 may be provided with a touch screen 110 to receive input (e.g., data, commands, etc.) from a user. For example, a user may operate the mobile electronic device 18 by touching the touch screen 110 and/or by performing gestures on the screen 110. In some embodiments, the touch screen 110 may be a capacitive touch screen, a resistive touch screen, an infrared touch screen, combinations thereof, and the like.

The mobile electronic device 18 may further include a user interface 112, which may comprise the touch screen 110, a keypad, buttons, switches, a wireless input device, a thumbwheel input device, a trackstick input device, data ports, and the like. The user interface 112 may further include one or more audio input or output devices, such as a microphone, speakers, and the like. The user interface 112 may be configured to enable a user to provide instructions to the processor 104 of the mobile electronics device 18.

The mobile electronic device 18 may also include a communication module 114 representative of communication functionality to permit mobile electronic device 18 to send/receive data between different devices (e.g., components/peripherals) and/or over the one or more networks 24 and 26 described above. Communication module 114 may be representative of a variety of communication components and functionality including, but not limited to: one or more antennas; a browser; a transmitter and/or receiver; a wireless radio; data ports; software interfaces and drivers; networking interfaces; data processing components; and so forth.

In use, the system 10 and server or apparatus 12 may perform a method for receiving and responding to complaints about a reviewable item, such as a purchased product or a retailer. Specifically, the apparatus 12 may receive complaints, via one of the electronic computing devices 18-22, from users regarding specific reviewable items and then electronically publish the complaint on a Web site or the like. The apparatus 12 may receive criteria, such as advertisement bidding criteria, from advertisers via advertising accounts set up thereon. Upon receipt of the complaint, the apparatus 12 may automatically send notifications to one of the advertisers associated with the reviewable item of the complaint, also referred to herein as an “owner advertiser.” Advertisers not associated with the reviewable item of the complaint may be referred to herein as “non-owner advertisers.” However, note that all advertisers using the system 10 may be owner advertisers or non-owner advertisers depending on the reviewable item featured in the complaint. The apparatus 12 may determine whether to display an advertisement from the owner advertiser or from the non-owner advertiser with the published complaint, based on the criteria received and/or based on which of the advertisers has placed a highest bid for displaying the advertisement. In some embodiments of the invention, advertisements such as coupons or vouchers from the owner advertiser are only displayed to the user who originally authored the complaint. The apparatus 12 may also send an automated redress message to the user from the owner advertiser to assist in resolving the complaint.

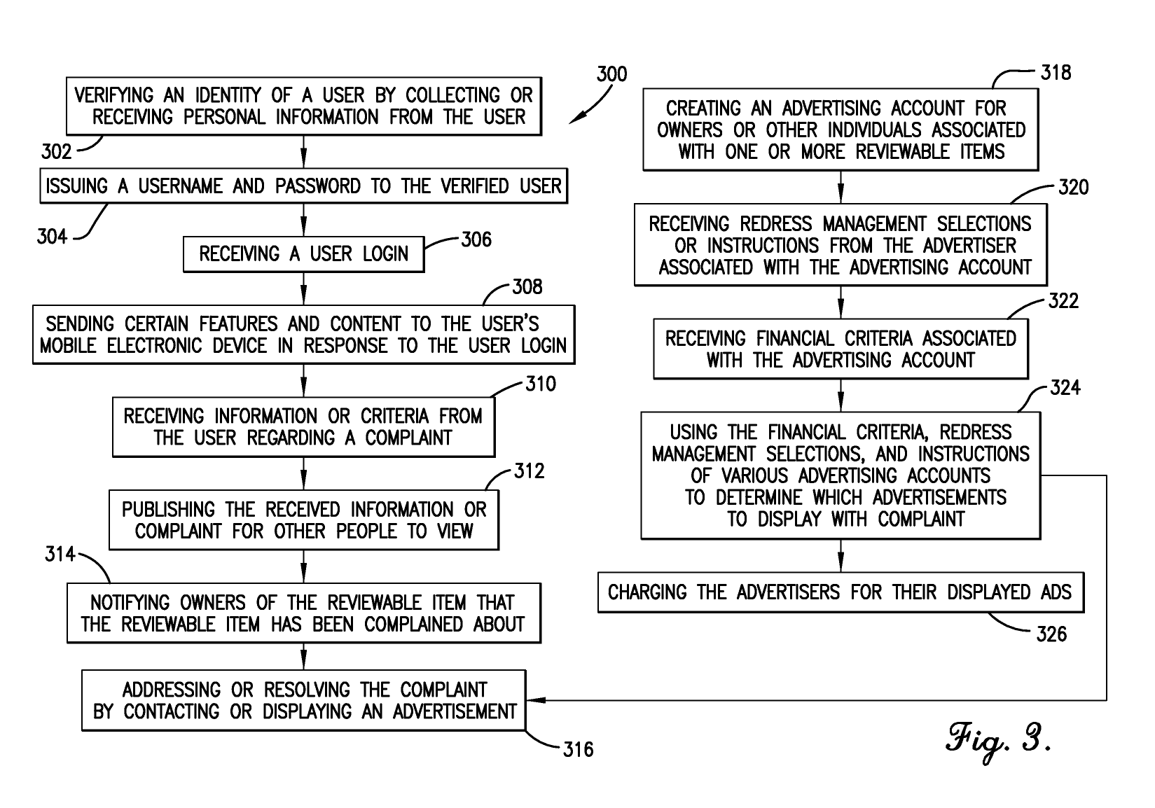

A method 300 for receiving and responding to complaints about the reviewable item, in accordance with various embodiments of the present invention, is shown in FIG. 3 and described in more detail below. The steps of the method 300 may be performed in the order as shown in FIG. 3, or they may be performed in a different order. Furthermore, some steps may be performed concurrently as opposed to sequentially. In addition, some steps may not be performed. Some of the steps may represent code segments or executable instructions of the computer program or applications described above.

The method 300 may include the step of verifying an identity of a user by collecting or receiving personal information via the system 10, as depicted in block 302. Then, the method 300 may include the step of issuing a username and password, via the apparatus 12 of the system 10, to a verified user, as depicted in block 304, so that re-verifying the user's identity is not necessary each time the user wishes to login to the system 10 and associated computer program described herein. In some embodiments of the invention, the system, 10 can verify the identity of the user by allowing the user to log in using the user's social media profile, email address, telephone number, fax number, street address, or other verifiable modes of personal communication.

Once the user's identity is verified, the method 300 may include the steps of receiving a user login, as depicted in block 306, and sending certain features and content to the one of the electronic computing devices 18-22 from which the user log in was received, as depicted in block 308. Specifically, when the user logs in to the system 10, data stored in the memory 16 of the apparatus 12 and/or graphics associated with a computer program and computer-executable code stored in the memory 16 of the apparatus 12 may be displayed on one of the electronic computing devices 18-22 being uses by the verified user. For example, complaints related to specific items of interest, items in close proximity to the user's geolocation (GPS), or other users associated with the user may be displayed to the user upon logging in. The user may also be provided with options presented on the display 108 of the user's mobile electronic device 18 for adding complaints, commenting on complaints, flagging users or complaints, adding complaints to a list of favorites, and/or sharing complaints. Other non-verified users or viewers may still be allowed limited viewing capabilities of various complaints submitted via the system 10, but may not be able to add complaints, comments, flags, etc. The options displayed to the user may also include setting up or editing a user profile. At least some of the user profile features may be customized by the user, such as an avatar, name, email, phone, gender, date of birth, location information, privacy settings, and the like. The user may also be presented with options to connect with profiles of other users and/or to view particular users' complaints. In some embodiments of the invention, the options may include linking the user profile with other social media profiles, websites, or the like.

Next, the method 300 may include the step of receiving information or criteria (e.g., user selections, text, audio, photos, videos, etc.) from the user regarding a complaint, as depicted in block 310. The information in step 310 may include identifying information associated with a reviewable item and a complaint about the reviewable item. The reviewable item may be, for example, products, businesses, places, events, organizations, or service providers. For example, the system 10 may receive search criteria pertaining to the reviewable item from the user, along with a selection of a search button to initiate the search. The system 10 may search the Internet and/or various accessible databases for websites, social media profiles, venues, GPS locations, database entries, and the like related to the reviewable item the user wishes to complain about. The system 10 may then provide the user with one or more choices of websites, social media profiles, or the like that the system 10 located through the search. In some embodiments of the invention, the user authoring the complaint can also link the websites and/or social media profile(s) to the complaint via the system 10. The complaint may include text, audio, video, photos, and the like. For example, the user may append a photograph, video, or other media related to the complaint and the reviewable item to further support details of the complaint.

Next, the method 300 may include the step of publishing the received information or complaint, as depicted in block 312, for other people to view, such as on a Web site or other remotely-accessible data-sharing platform. That is, the system 10 may share and/or publish the complaint such that it is accessible by the author of the complaint, as well as other verified users. In addition, any anonymous, non-verified user with a direct link (e.g., a Web address) to a complaint may view the complaint. The complaint may be displayed on a searchable Web page, a social media profile or page, otherwise accessible in a shared database by a smart phone app, posted on an internet-accessible message board, or otherwise shared with other verified users and/or the public in general.

In some embodiments of the invention, the method 300 may further comprise the step of notifying owners of the reviewable item or other individuals or systems associated with the reviewable item, that the reviewable item has been complained about, as depicted in block 314. For example, linked resources, content, GPS location data, and/or social media profiles associated with the reviewable item may be tagged, linked (e.g., a Web address link), or otherwise identified in the complaint. This notification regarding the complaint of the reviewable item may also be provided to the owner or other associated individuals via traditional and non-traditional means of communication, such as direct mail, API notifications to the owner advertiser's CRM or case management system, email, text message (SMS), push notification, telephone voice call, and the like. Furthermore, these notifications may be provided via an advertising account, as described in detail below.

The method 300 may also include a step of addressing or resolving the complaint by contacting or displaying an advertisement to the user (i.e., complainant or author of the complaint), as depicted in block 316. For example, owners or other individuals or systems associated with the reviewable item may opt to provide automated redress for their reviewable items. The system 10 may automatically contact the author of the complaint on behalf of the owner to assist in the redress process related to that complaint. That is, automated redress messages can provide the complainant with a personalized email, text message (SMS), push notification, telephone voice call, or the like, and may be aimed at assisting in the complaint resolution process. Additionally and/or alternatively, the system 10 may receive an indication from the complainant or author of the complaint that the complaint has been resolved. For example, the user may select a “resolve” button from a menu of complaint status options and provide information regarding how the complaint was addressed or resolved. This resolution may be described in text, images, audio, video, or the like, and may be available to view along with the original complaint. Additionally and/or alternatively, the system 10 may receive an indication from the complainant or author of the complaint that the complaint has been closed and un-resolved. For example, the user may select a “close and mark un-resolved” button from a menu of complaint status options and provide information regarding how the complaint was improperly addressed, ignored, or failed to be resolved. This information may be described in text, images, audio, video, or the like, and may be available to view along with the original complaint.

In some embodiments of the invention, the system 10 can document the complaint which triggered the automated redress message and notify the associated owner or other individuals or systems associated with the reviewable item features in the complaint. Additional reporting about the automated redress message can be recorded as the complainant interacts with the message. For example, the additional reporting may include the status of the message (e.g., unopened, clicked, accepted, declined, etc.), date and/or time interaction took place, subsequent complaints about the same reviewable item from the same user or a different user, status of the complaint (e.g., open, resolved, unresolved or closed), etc.

Additionally or alternatively, as noted above, the complaint may be addressed via an advertisement displayed to the complainant or others view the complaint. In some instances, the advertisement may promote a related and/or competing product, place, business, organization, event, service, or service provider associated with a competitor or owner other than the owner of the reviewable item in the complaint. This type of advertisement may be referred to herein as an alternative solution ad (AS). Alternatively, the advertisement may be from the owner of the reviewable item, or other individuals or systems associated with the reviewable item, and may be tailored specifically to respond to the user's complaint. This type of advertisement may be referred to herein as a redress management ad (RM).

In some embodiments of the invention, the method 300 may include creating an advertising account for owners or other individuals associated with one or more reviewable items, as depicted in block 318. Users of advertising accounts may be referred to herein as advertisers. During creation of the advertising account and/or editing thereof, the system 10 may verify the identity of the advertisers, verify the reviewable items owned by that advertiser, and collect information related to advertising and redress automation. The advertiser may log in to the advertising account using a login name and password, as with the other users noted above.

In some embodiments of the invention, the advertiser may verify ownership of the reviewable items by securely logging into and linking the reviewable item's social media profile to the advertising account. Furthermore, the system 10 may save login credentials for the advertiser and automatically verify reviewable item ownership through the previously-identified social media profile or other identifying information. In other embodiments of the invention, the system 10 may verify ownership of the reviewable item by collecting relevant information sufficient to meet the system's criteria for identification and ownership.

The method 300 may also comprise the step of receiving redress management selections, criteria, or instructions from the advertiser, as depicted in block 320. That is, once the advertiser is logged in to the advertising account, redress management advertising may be selected, set up, and customized by the advertiser via any of the electronic computing devices 18-22 used for login. The system 10 may collect advertisement and redress automation preferences for each owned reviewable item associated with the advertising account. These preferences may be, for example, related to geographic locations in which the advertiser's ads should be used, age or gender of a target audience, type of electronic computing device accessing the system 10, time of day, day of week, month, season, other frequency settings, and the like. Furthermore, the redress management selections or instructions may include a message and associated content to be automatically delivered to verified users complaining about one or more of the reviewable items associated with the advertising account. Which of these verified users receive the message may also be based on the preferences selected and described above. Furthermore, different types of redress management may be set up for different types of complaints based on one or more of the following: type of issue (e.g., price, attitude, service, quality, speed, etc.), severity of the issue (e.g., mild, medium, severe, etc.), and issue privacy settings (e.g., public, private, or hybrid, with some information of the complaint public and some information private). The message and associated content may be input by the associated advertiser via an automated redress message/content setup page or menu option provided on one of the electronic computing devices 18-22. Additionally or alternatively, the associated advertiser may input the message and associated content manually via any connected device and via communication channels including but not limited to email, telephone voice call, SMS (text message), API, video, online chat, etc.

The method 300 may include the step of receiving financial criteria associated with the advertising account, as depicted in block 322. For example, the advertiser may set a monthly advertising budget, a maximum cost per views of their ads that the advertiser is willing to spend, whether the advertiser wants to utilize RM ads for their reviewable items associated with their advertising account, and the like. The advertising budget may be a pre-paid amount, a pre-determined limit, unlimited with quota warnings provided to the advertiser, etc.

The advertiser may bid on advertising related to RM ads or AS ads, depending on settings and preferences set up in their advertising account. If the advertiser has verified ownership of a reviewable item and enabled an RM ad campaign for that reviewable item, the system 10 may allow the advertiser to bid on a chance to advertise on a complaint using RM ads. The advertiser can also enable both RM and AS ads and have multiple campaigns running simultaneously based on the reviewable item, type of reviewable item, category, keyword, location of complaint, location of the reviewable item, demographics, technographics, or other criteria.

In some embodiments of the invention, the advertiser may not bid on a reviewable item's proper name for AS ads if the advertiser has not proven ownership or met verification requirements to be associated with that reviewable item. However, the advertiser may set up advertising and bid on derivatives of that proper name, or categories, keywords, or other criteria related to that reviewable item.

In some embodiments of the invention, the advertiser may not be allowed to bid on any advertising because they have not set up a monthly budget or have indicated that they only wish to utilize automated redress. In this case, the system 10 may send an automated redress message to the author of the complaint based on preferences set up via the advertising account associated with the reviewable item described or linked to in the complaint.

The method 300 may also include the step of using the financial criteria, redress management selections, and instructions of various advertising accounts to determine which advertisements to display with the complaint and/or to users submitting the complaints, as depicted in block 324. For example, the system 10 may determine which advertiser is the highest bidder for the complaint based on categories, criteria, and keywords derived from the complaint details received from the user.

In some embodiments of the invention, the system 10 may determine whether the advertiser that is the subject of the user's complaint is also the highest bidder. When an advertiser is the highest bidder, has setup or enabled RM ads, and is the owner of or otherwise associated with the reviewable item of the complaint, the system 10 may display the advertiser's RM ad. The RM ad may be made visible to the author of the complaint while blocking any advertising (including the RM ad) from showing with that complaint to all other users that view the complaint. For example, the RM ad may be a voucher or coupon specifically created to assist in resolving the associated complaint. Thus, the voucher or coupon is only viewable by the author of the complaint. However, even if other viewers or verified users cannot view the RM ad, all AS ads may still be blocked from being displayed to these other viewers of the complaint. Alternatively, the RM ad may be shown to all verified users or even publically displayed.

However, if the highest bidder is not the advertiser owning or otherwise associated with the reviewable item of the complaint, the system may display the AS ad provided by the highest bidder. The AS ad may be viewable by the author of the complaint and all users or viewers (e.g. the general public) that view the complaint.

In some embodiments of the invention, if the highest bidder for the complaint is the advertiser or advertising account associated with the reviewable item subject to the complaint, but that advertiser has not enabled RM ads for that owned reviewable item, the second-highest bidder's AS ad may be displayed to the author of the complaint and/or other verified users viewing the complaint. Furthermore, if the advertising account's associated budget has expired or been depleted, their associated RM or AS ads may be deleted, removed, or made no longer visible and their advertiser account may be disabled. Furthermore, the advertiser may be notified of their budget expiring or being depleted. The system 10 may then determine the next-highest bidder and display their associated RM or AS ad with the complaint.

The method 300 may include the step of billing and/or charging the advertisers for their displayed ads, as depicted in block 326. For example, the system 10 may monitor each time a complaint is viewed, and may charge the advertiser per view of an ad displayed with the complaint. In some embodiments of the invention, AS ads may be blocked by RM ads, and the system 10 may charge the advertiser associated with the reviewable item subject to the complaint each time an AS ad is blocked, based on the number of views of the complaint from the author and other users or viewers. The system 10 may also charge the advertiser for each view of their AS ad by any view and/or user.

Although the invention has been described with reference to the preferred embodiment illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A non-transitory computer-readable storage medium with an executable program stored thereon for receiving and responding to complaints, wherein the program comprises:
a code segment for receiving a complaint from a user regarding a reviewable item, wherein the complaint is received from an electronic computing device;
a code segment for electronically publishing the complaint for remote viewing by other people; and
a code segment for displaying to the user or any viewer, with the complaint, a redress management advertisement from an owner advertiser associated with the reviewable item or displaying an alternative solution advertisement from a non-owner advertiser not associated with the reviewable item.

2. The non-transitory computer-readable storage medium of claim 1, the program further comprising: a code segment for determining whether to display the redress management advertisement or the alternative solution advertisement based on criteria submitted by the owner advertiser and the non-owner advertiser and on which of the owner and non-owner advertisers makes a highest bid for displaying the redress management or alternative solution advertisements.

3. The non-transitory computer-readable storage medium of claim 2, wherein the code segment for displaying the redress management or alternative solution advertisements includes displaying the alternative solution advertisement when the criteria submitted by the owner advertiser indicates a selection to not bid on displaying the redress management advertisement when the reviewable item is mentioned in the complaint.

4. The non-transitory computer-readable storage medium of claim 1, the program further comprising:
a code segment for receiving an automated redress message from the owner advertiser; and
a code segment for sending the automated redress message to the user when the complaint regarding the reviewable item is received.

5. The non-transitory computer-readable storage medium of claim 2, wherein the code segment for displaying the redress management or alternative solution advertisements further comprises blocking the alternative solution advertisement when the owner advertiser submits the highest bid.

6. The non-transitory computer-readable storage medium of claim 2, wherein the code segment for displaying the redress management or alternative solution advertisements further comprises displaying the redress advertisement only to the user on the electronic computing device when the owner advertiser submits the highest bid, preventing the other people remotely viewing the complaint from viewing the redress advertisement.

7. The non-transitory computer-readable storage medium of claim 2, wherein the criteria submitted by the owner advertiser and the non-owner advertiser includes at least one of an advertising budget, a maximum amount to spend or bid per advertisement or per view, and whether or not the owner advertiser wants to bid on displaying the redress management advertisement for the complaint regarding the reviewable item.

8. The non-transitory computer-readable storage medium of claim 1, the program further comprising a code segment for automatically notifying the owner advertiser of receipt of the complaint regarding the reviewable item.

9. The non-transitory computer-readable storage medium of claim 1, wherein the redress management advertisement is a coupon or voucher from the owner advertiser.

10. The non-transitory computer-readable storage medium of claim 1, wherein the alternative solution advertisement promotes a competing reviewable item from the non-owner advertiser.

11. A non-transitory computer-readable storage medium with an executable program stored thereon for receiving and responding to complaints, wherein the program comprises:
a code segment for receiving a complaint from a user regarding a reviewable item, wherein the complaint is received from an electronic computing device;
a code segment for electronically publishing the complaint for remote viewing by other people;
a code segment for determining whether to display to the user a redress management advertisement from an owner advertiser associated with the reviewable item or an alternative solution advertisement from a non-owner advertiser not associated with the reviewable item, wherein the determining is based on criteria submitted by the owner advertiser and the non-owner advertiser, and on which of the owner and non-owner advertisers submits a highest bid for displaying the redress management or alternative solution advertisements, wherein the redress management advertisement is a coupon or voucher from the owner advertiser, wherein the alternative solution advertisement promotes a competing reviewable item from the non-owner advertiser; and
a code segment for displaying the redress management advertisement or the alternative solution advertisement with the complaint based on results from executing the determining code segment.

12. The non-transitory computer-readable storage medium of claim 11, wherein the code segment for displaying the redress management or alternative solution advertisements includes displaying the alternative solution advertisement when criteria submitted by the owner advertiser indicates a selection to not bid on displaying the redress management advertisement with the complaint regarding the reviewable item.

13. The non-transitory computer-readable storage medium of claim 11, the program further comprising:
a code segment for receiving an automated redress message from the owner advertiser; and
a code segment for sending the automated redress message to the user when the complaint regarding the reviewable item is received.

14. The non-transitory computer-readable storage medium of claim 11, wherein the code segment for displaying the redress management or alternative solution advertisements further comprises only displaying the redress advertisement to the user on the electronic computing device, preventing the other people remotely viewing the complaint from viewing the redress advertisement and also preventing other people remotely viewing the complaint from viewing the alternate solution advertisement.

15. The non-transitory computer-readable storage medium of claim 11, wherein the criteria submitted by the owner advertiser and the non-owner advertiser includes at least one of an advertising budget, a maximum amount to spend or bid per advertisement or per view, and selections regarding if or when to bid on displaying the redress management advertisement.

16. The non-transitory computer-readable storage medium of claim 11, the program further comprising a code segment for automatically notifying the owner advertiser of receipt of the complaint regarding the reviewable item.

17. A method for receiving and responding to complaints, wherein the method comprises:
receiving, with a server from an electronic computing device, a complaint from a user regarding a selected one of a plurality of reviewable items;
electronically publishing the complaint, with the server, granting remote viewing access to other people over Internet and communication channels;
receiving, with the server, criteria from a plurality of advertisers in a plurality of advertising accounts, wherein at least one of the advertisers is an owner advertiser associated with the selected one of the plurality of reviewable items in the complaint, wherein the criteria includes advertisement bidding criteria;
automatically sending notifications from the server to the owner advertiser upon receipt of the complaint regarding the selected one of the reviewable items;
determining, automatically with the server, whether to display to the user a redress management advertisement from the owner advertiser or an alternative solution advertisement from a non-owner advertiser not associated with the selected one of the reviewable items, wherein the determining is based on the criteria received from the plurality of advertisers and on which of the owner and non-owner advertisers has a highest bid for displaying the redress management or alternative solution advertisements with the complaint, wherein the redress management advertisement is a coupon or voucher from the owner advertiser, wherein the alternative solution advertisement promotes a competing one of the reviewable items from the non-owner advertiser;
displaying, on the electronic computing device via the server, the redress management advertisement or the alternative solution advertisement with the complaint, based on results of the determining step;
receiving, with the server, an automated redress message from the owner advertiser; and
sending, with the server, the automated redress message to the user when the complaint regarding the selected one of the reviewable items is received.

18. The method of claim 17, wherein the step of displaying the redress management or alternative solution advertisements includes displaying the alternative solution advertisement when the criteria submitted by the owner advertiser indicates a selection to not bid on displaying the redress management advertisement with the complaint regarding the selected one of the reviewable items.

19. The method of claim 17, wherein the step of displaying the redress management or alternative solution advertisements further comprises only displaying the redress advertisement to the user on the electronic computing device, preventing the other people remotely viewing the complaint from viewing the redress advertisement and also preventing other people remotely viewing the complaint from viewing the alternate solution advertisement.

20. The method of claim 17, further comprising the step of charging or billing one of the advertisers associated with any of the redress management or alternative solution advertisements displayed with the complaint.
